(19) United States
(12) Patent Application Publication
(10) Pub. No.: US 2003/0210208 A1
(43) Pub. Date: Nov. 13, 2003

(54) Portable computer capable of displaying foreign image signal

(75) Inventors: Simon Pu, Taipei (TW); Macalas Yen, Taipei (TW); Yun-Ching Chen, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: VIA Technologies, Inc., Taipei (TW)

(21) Appl. No.: 10/217,270

(22) Filed: Aug. 12, 2002

(30) Foreign Application Priority Data
May 8, 2002 (TW) 091109542

(51) Int. Cl. G09G 5/00

(52) U.S. Cl. 345/1.1

(57) ABSTRACT

A portable computer capable of displaying a foreign image signal from an external image-signal generator is disclosed. The portable computer includes a computer host generating a local image signal in a first operation condition and suspending the local image signal in a second operation condition, a signal transferring device in communication with a signal output channel of the external image-signal generator for transferring the foreign image signal received from the image signal generator, and a display device electrically connected to the computer host and the signal transferring device for receiving and displaying the local image signal in the first operation condition, and receiving and displaying the foreign image signal in the second operation condition.

### FIELD OF THE INVENTION

The present invention relates to a portable computer, and more particularly to a portable computer being able to display a foreign image signal.

### BACKGROUND OF THE INVENTION

Along with the technology development, the portable computer brings the human life a lot of convenience. Thus, it becomes more and more popular.

Please refer to FIG. 1A which is a partial functional block diagram illustrating a conventional portable computer. The portable computer includes a liquid crystal display (LCD) 10 and a computer host 11. The LCD 10, via a low voltage differential signaling (LVDS) transmitter 113 and receiver 101, receives and displays image data from a graphics controller 111 of the computer host 11. Alternatively, the graphics controller 111 can transmit the image data into an external cathode ray tube (CRT) monitor or digital visual interface (DVI) digital monitor for displaying on the external monitor via a transmission minimized differential signaling (TMDS) transmitter 114, a digital visual interface (DVI) connector/D-sub connector 112 and a transmission minimized differential signaling (TMDS) receiver 121.

Please refer to FIG. 1B which is a partial functional block diagram illustrating another conventional portable computer. The structure and function of the portable computer of FIG. 1B are similar to those of FIG. 1A except that a TMDS receiver 102 and a TMDS transmitter 115 are used for transmitting the image data from the computer host 11 to the LCD 10 instead of the LVDS receiver 101 and the LVDS transmitter 113.

Please refer to FIG. 1C which is a partial functional block diagram illustrating a further conventional portable computer. The structure and function of the portable computer of FIG. 1C are similar to those of FIG. 1A except that the LVDS transmitter 113 is built in the graphics controller 118.

In the above conventional portable computers, when the computer host 11 is shutdown or the operating system does not operate, the LCD is also left unused. As is known, the LCD is very expensive, so it will be some kind of waste if the LCD is not made use of. For an operating system supporting dual-monitor display, the LCD of the portable computer, however, cannot be used as an additional monitor because it cannot receive any image signal from an external device. In this situation, the user has no choice but to buy another monitor for the dual-monitor displaying purpose, and still leave the LCD of the portable computer unused. Thus, it is really space- and cost-inefficient.

Therefore, the purpose of the present invention is to develop a portable computer capable of displaying a foreign image data to deal with the above situations encountered in the prior art.

### SUMMARY OF THE INVENTION

An object of the present invention is to provide a portable computer capable of displaying a foreign image signal for making full use of the liquid crystal display (LCD) of the portable computer.

According to an aspect of the present invention, there is provided a portable computer capable of displaying a foreign image signal from an external image-signal generator. The portable computer includes a computer host generating a local image signal in a first operation condition and suspending the local image signal in a second operation condition, a signal transferring device in communication with a signal output channel of the external image-signal generator for transferring the foreign image signal received from the image signal generator, and a display device electrically connected to the computer host and the signal transferring device for receiving and displaying the local image signal in the first operation condition, and receiving and displaying the foreign image signal in the second operation condition.

Preferably, the computer host is controlled by an operating system (OS) in the first operation condition and not controlled by an operating system (OS) in the second operation condition.

For example, the foreign image signal can be a digital modulating image signal of a transmission minimized differential signaling (TMDS) format. The display device preferably includes a receiver for receiving the foreign digital modulating image signal in the first operation condition, and the local image signal in the second operation condition.

In an embodiment, the receiver is a low voltage differential signaling (LVDS) receiver. The signal transferring device includes a digital visual interface (DVI) connector in communication with the signal output channel of the external image-signal generator for receiving the foreign digital modulating image signal, a first TMDS receiver in communication with the DVI connector for recovering the foreign digital modulating image signal into a digital image data, and a second LVDS transmitter in communication with the TMDS receiver for outputting a digital modulating image data of a first LVDS format converted from the digital image data. Preferably, the local image signal is generated by a graphics controller, and outputted by a first LVDS transmitter in the first operation condition.

In another embodiment, the receiver is a TMDS receiver. The signal transferring device includes a digital visual interface (DVI) connector in communication with the signal output channel of the external image-signal generator for receiving the foreign digital modulating image signal, and a first TMDS transmitter in communication with the DVI connector for directly outputting the foreign digital modulating image signal. Preferably, the local image signal is generated by a graphics controller, and outputted by a second TMDS transmitter in the first operation condition.

For example, the external image signal generator can be a laptop computer, a desktop computer, a personal digital assistant (PDA) or a cellular phone.

For example, the display can be a planar display and the planar display can be a liquid crystal display (LCD).

According to another aspect of the present invention, there is provided a portable computer capable of displaying a foreign image signal from an external image-signal generator. The portable computer includes a computer host generating a local image signal, a signal transferring device in communication with a signal output channel of the external image-signal generator and the computer host for transferring the local image signal in a first operation condition and the foreign image signal in a second operation condition, and a display device electrically connected to the signal transferring device for receiving and displaying the local image signal in the first operation condition, and the foreign image signal in the second operation condition.

Preferably, the computer host is shutdown in the second operation condition.

### BRIEF DESCRIPTION OF THE DRAWINGS

The present invention may best be understood through the following description with reference to the accompanying drawings, in which:

FIGS. 1A-1C are partial functional block diagrams illustrating three conventional portable computers, respectively;

FIGS. 2A-2C are partial functional block diagrams illustrating three examples of a similar portable computer structure according to a preferred embodiment of the present invention, respectively, wherein the computer host of the portable computer includes a graphics controller and a specific transmitter; and

FIGS. 3A-3B are partial functional block diagrams illustrating three examples of a similar portable computer structure according to another preferred embodiment of the present invention, respectively, wherein the computer host and the signal transferring device share one transmitter.

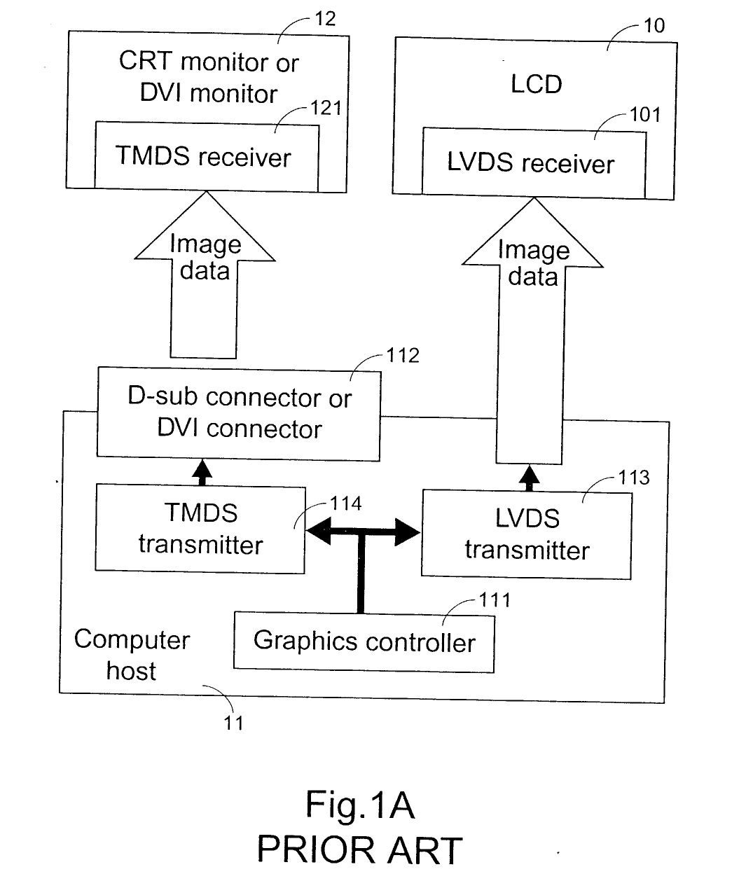

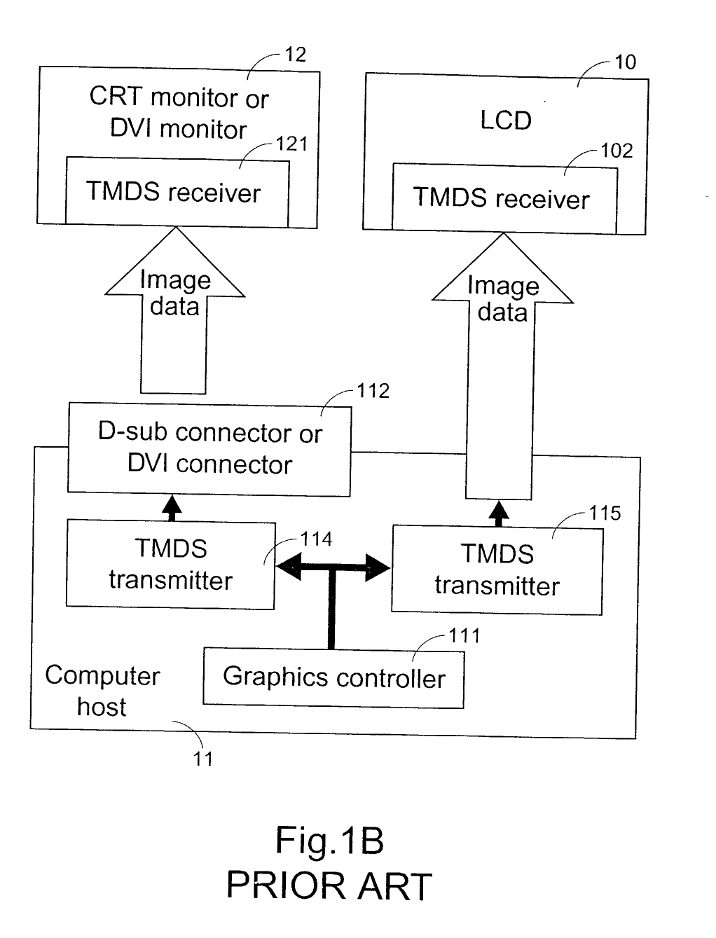

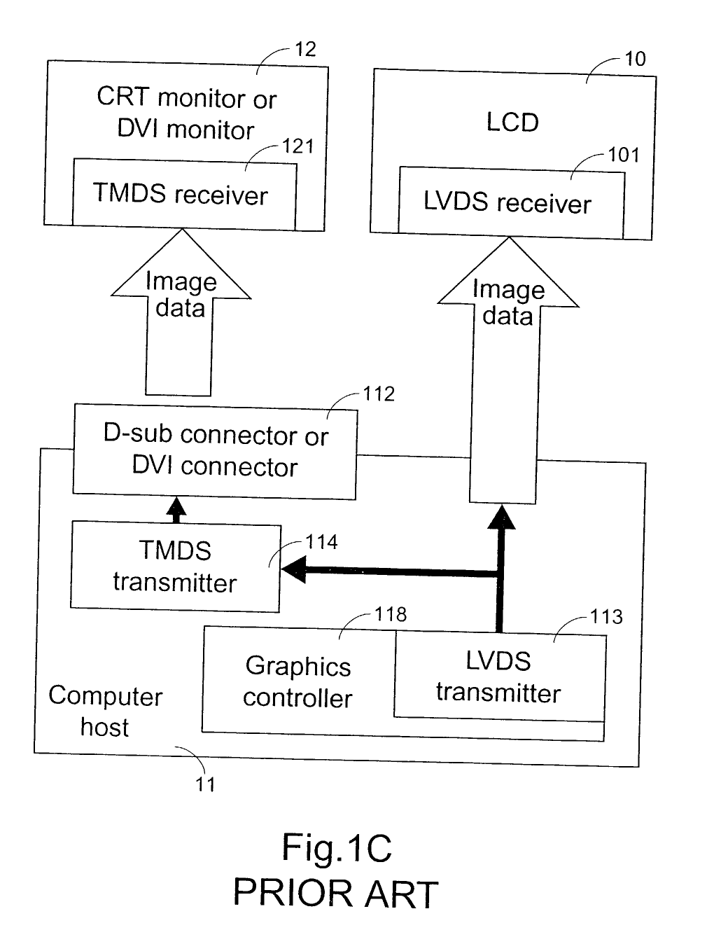

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

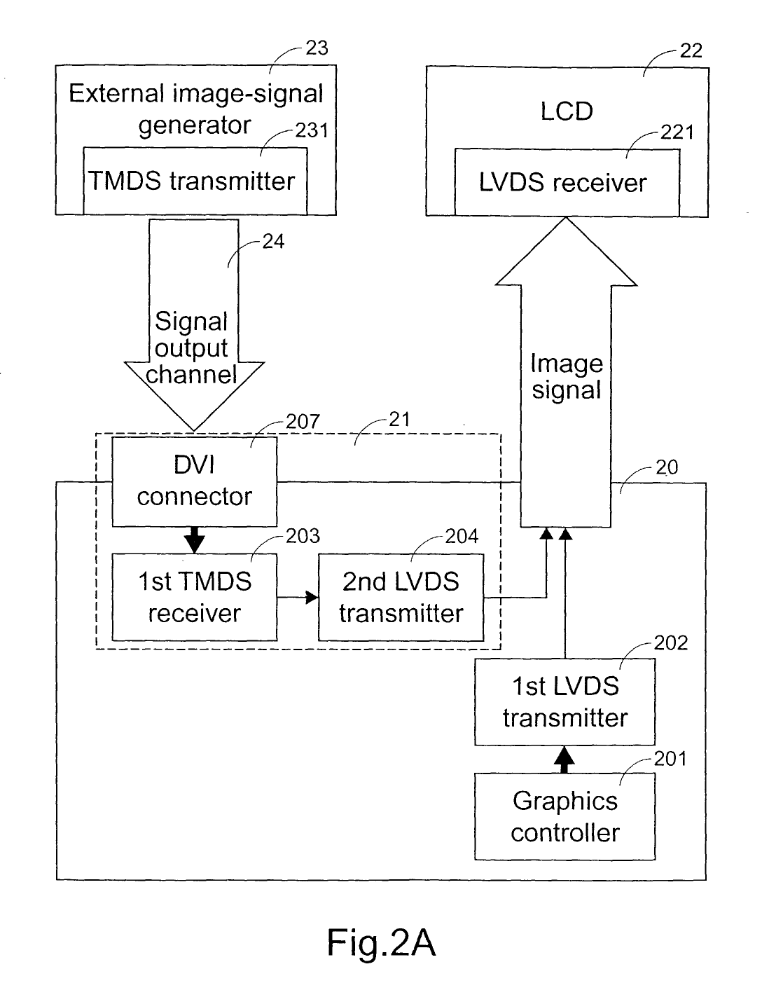

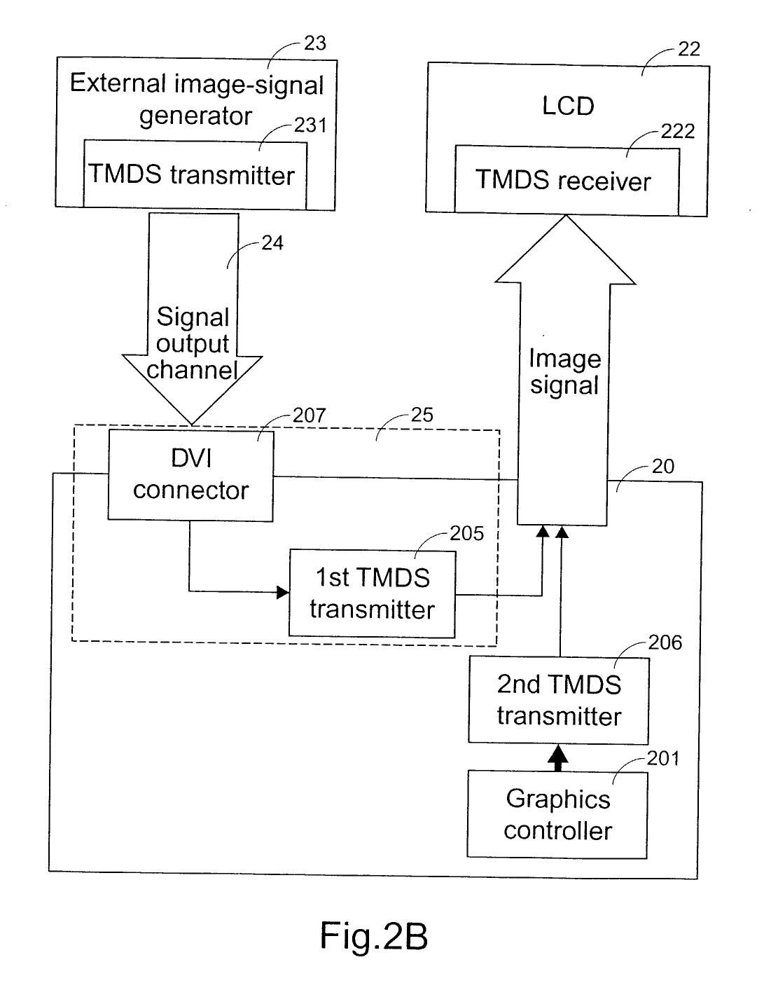

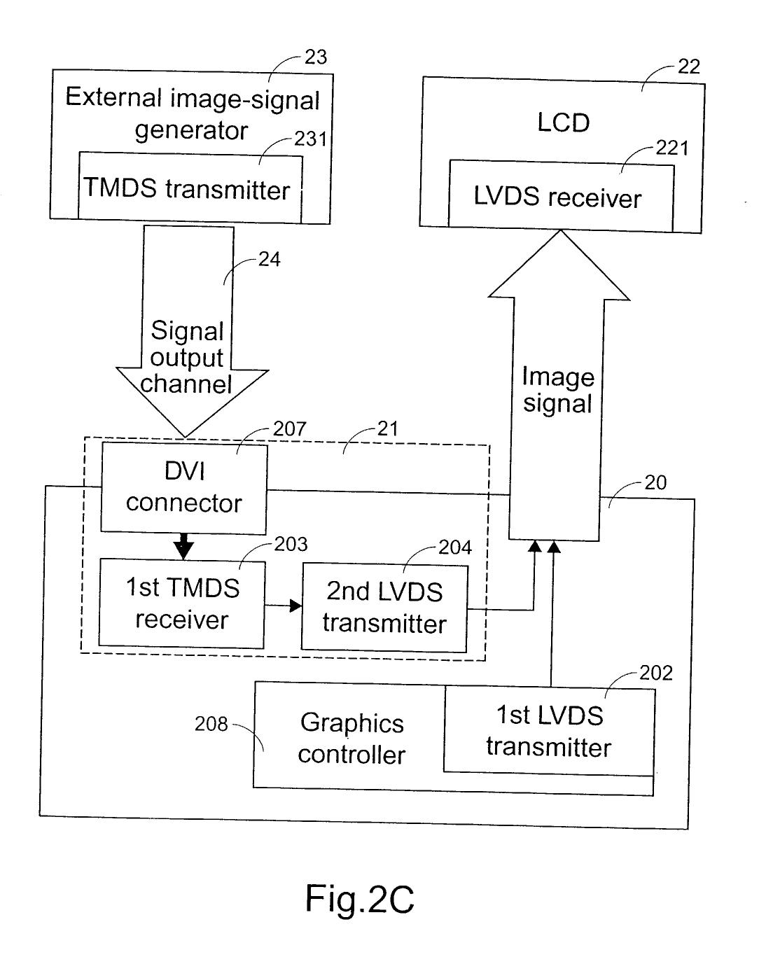

FIGS. 2A-2C schematically show different but similar portable computer structures according to the present invention. In the embodiments of FIGS. 2A-2C, the computer host of the portable computer includes a graphics controller and a specific transmitter for converting and outputting a local image signal to a display device. Referring to FIG. 2A which shows an example of the portable computer structure according to the present invention, the portable computer includes a computer host 20, a signal transferring device 21 and a liquid crystal display (LCD) 22. The computer host 20 includes a graphics controller 201 and a first low voltage differential signaling (LVDS) transmitter 202. The signal transferring device 21 includes a digital visual interface (DVI) connector 207, a first transmission minimized differential signaling (TMDS) receiver 203 and a second LVDS transmitter 204, while the LCD 22 includes a LVDS receiver 221.

When the computer host 20 is in operation and controlled by an operating system (OS), a digital image signal generated from the graphics controller 201 is converted into a digital modulating image signal of a low voltage differential signaling (LVDS) format and outputted by the first LVDS transmitter 202. Subsequently, the LVDS receiver 221 of the LCD 22 receives and displays the digital modulating image signal.

On the contrary, when the computer host 20 is not controlled by the operating system and in a shutdown condition, the DVI connector 207 of the portable computer may receive a foreign digital modulating signal of a TMDS format from an external image-signal generator 23 via a signal output channel 24 in communication with the DVI connector 207, and allow the foreign digital modulating signal of the TMDS format to be displayed on the LCD 22 of the portable computer. Since the formats required by the transmitter 204 of the DVI connector 207 and the receiver 221 of the LCD 22 are different in this embodiment, i.e. the DVI connector 207 processes signals of a TMDS format and the receiver 221 of the LCD 22 processes signals of a LVDS format, the foreign digital modulating signal of the TMDS format needs to be recovered into a digital image data by the first TMDS receiver 203 at first. Subsequently, the second LVDS transmitter 204 converts the digital image data into a digital modulating signal of a LVDS format, and transmits the digital modulating signal of the LVDS format out. Then, the LCD 22 receives and displays the digital modulating signal of the LVDS format via the LVDS receiver 221. In such way, the LCD 22 is able to display a foreign image signal from the external image-signal generator 23.

Please refer to FIG. 2B. The structure and function of the portable computer in FIG. 2B are similar to those in FIG. 2A except that the receiver 222 of the LCD 22 is a TMDS receiver, and the transmitter 206 of the computer host 20 is a TMDS transmitter. In this case, it is unnecessary to recover and convert the foreign digital modulating image signal of the TMDS format into an LVDS format because the receiver 222 of the LCD 22 in this embodiment processes signals of the same format as the DVI connector 207. Hence, the signal transferring device 25 only includes a DVI connector 207 and a TMDS transmitter 205. When a foreign image signal of the TMDS format from the external image-signal generator 23 is received by the DVI connector 207, the DVI connector 207 directly transmits the foreign image signal of the TMDS format into the first TMDS transmitter 205, from which the foreign image signal of the TMDS format is forwarded to the LCD 22 via the TMDS receiver 222. As for the optional transmission and display of the local image signal, the transmitter 206 cooperating with the graphics controller 201 is of a TMDS format to comply with the specification of the receiver 222 of the LCD 22.

Please refer to FIG. 2C. The structure and function of the portable computer in FIG. 2C are similar to those in FIG. 2A except that the first LVDS transmitter 202 is built in the graphics controller 208.

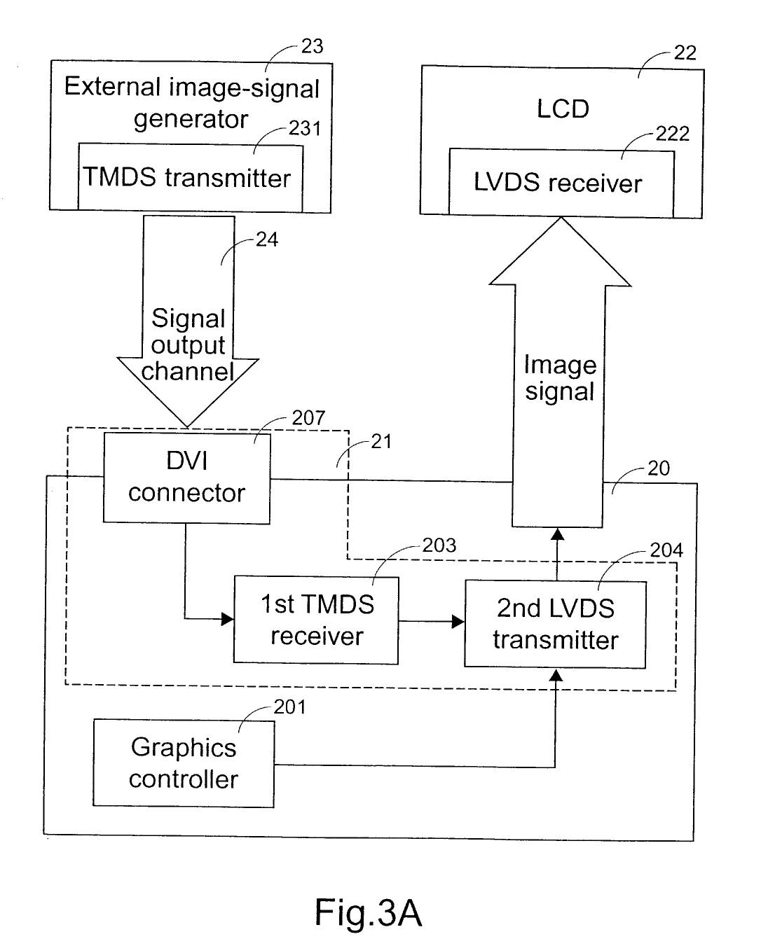

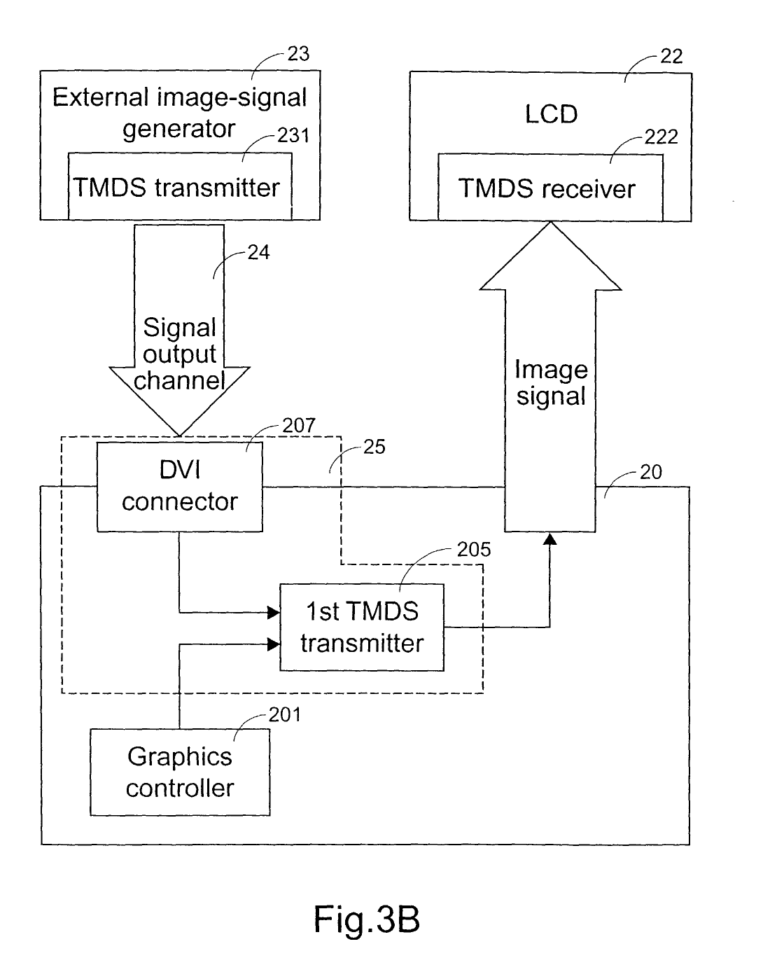

FIGS. 3A-3B are partial functional block diagrams illustrating other embodiments of a portable computer structure according to the present invention. In either of the embodiments of FIGS. 3A and 3B, the computer host and the signal transferring device share one transmitter. As shown in FIG. 3A, the graphics controller 201 and the signal transferring device 21 share the second LVDS transmitter 204. When the computer host 20 is controlled by the operating system, i.e. in the operation condition, a digital image signal from the graphics controller 201 is transmitted to the LCD 22 via the second LVDS transmitter 204 and the LVDS receiver 222. Once the computer host is not controlled by the operating system, e.g. in the shutdown condition, the LCD 22 can be used to display a foreign digital modulating image signal from an external image-signal generator 23. The foreign digital modulating image signal is transmitted via the signal transferring device 21 comprising the DVI connector 207, the first TMDS receiver 203 and the second LVDS transmitter 204. Likewise, the TMDS receiver 203 is provided for recovering the foreign digital modulating image signal of the TMDS format into a digital image data, and the digital image data is transferred to the LCD 22 via the LVDS transmitter 204 and the LDVS receiver 222.

Please refer to FIG. 3B. The structure and the function of the portable computer in FIG. 3B are similar to those in FIG. 2B except that the graphics controller 201 uses the transmitter 205 of the signal transferring device 25 to send the local image signal when the computer is in operation. Hence, the foreign digital modulating image signal received by the DVI connector 207 is directly transmitted to the first TMDS transmitter 205 and further to the LCD 22 because the format of the signal processed by the receiver 222 of the LCD 22 is the same as that processed by the DVI connector 207.

In the above embodiments, the external image-signal generator, for example, can be a laptop computer, a desktop computer, a personal assistant (PDA) or a cellular phone. For example, the operating system of the laptop or desktop computer is Windows, and that of the PDA is Plam or WinCE. Moreover, the signal output channel can be performed by a cable or via wireless transmission.

To sum up, the portable computer according to the present invention is able to display a foreign image signal when the computer host is not controlled by the operating system or is shutdown. For an operating system supporting dual-monitor display, the LCD of the portable computer can be used as an additional monitor because it can receive the image signal from an external device. Thus, the user does not need to buy another monitor for the dual-monitor displaying purpose, and the LCD of the portable computer can be made a good use according to the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable computer capable of displaying a foreign image signal from an external image-signal generator, comprising:
a computer host generating a local image signal in a first operation condition and suspending said local image signal in a second operation condition;
a signal transferring device in communication with a signal output channel of said external image-signal generator for transferring said foreign image signal received from said image signal generator; and
a display device electrically connected to said computer host and said signal transferring device for receiving and displaying said local image signal in said first operation condition, and receiving and displaying said foreign image signal in said second operation condition.

2. The portable computer according to claim 1 wherein said computer host is controlled by an operating system (OS) in said first operation condition, and not controlled by an operating system (OS) in said second operation condition.

3. The portable computer according to claim 1 wherein said foreign image signal is a digital modulating image signal of a transmission minimized differential signaling (TMDS) format.

4. The portable computer according to claim 3 wherein said display device includes a receiver for receiving said foreign digital modulating image signal in said first operation condition, and said local image signal in said second operation condition.

5. The portable computer according to claim 4 wherein said receiver is a low voltage differential signaling (LVDS) receiver, and said signal transferring device includes:
a digital visual interface (DVI) connector in communication with said signal output channel of said external image-signal generator for receiving said foreign digital modulating image signal;
a first TMDS receiver in communication with said DVI connector for recovering said foreign digital modulating image signal into a digital image data; and
a second LVDS transmitter in communication with said TMDS receiver for outputting a digital modulating image data of a first LVDS format converted from said digital image data.

6. The portable computer according to claim 5 wherein said local image signal is generated by a graphics controller, and outputted by a first LVDS transmitter in said first operation condition.

7. The portable computer according to claim 4 wherein said receiver is a TMDS receiver, and said signal transferring device includes:
a digital visual interface (DVI) connector in communication with said signal output channel of said external image-signal generator for receiving said foreign digital modulating image signal; and
a first TMDS transmitter in communication with said DVI connector for directly outputting said foreign digital modulating image signal.

8. The portable computer according to claim 7 wherein said local image signal is generated by a graphics controller, and outputted by a second TMDS transmitter in said first operation condition.

9. The portable computer according to claim 1 wherein said external image signal generator is one selected from a group consisting of a laptop computer, a desktop computer, a personal digital assistant (PDA) and a cellular phone.

10. The portable computer according to claim 1 wherein said display is a planar display.

11. The portable computer according to claim 10 wherein said planar display is a liquid crystal display (LCD).

12. A portable computer capable of displaying a foreign image signal from an external image-signal generator, comprising:
a computer host generating a local image signal;
a signal transferring device in communication with a signal output channel of said external image-signal generator and said computer host for transferring said local image signal in a first operation condition and said foreign image signal in a second operation condition; and
a display device electrically connected to said signal transferring device for receiving and displaying said local image signal in said first operation condition, and said foreign image signal in said second operation condition.

13. The portable computer according to claim 12 wherein said computer host is controlled by an operating system (OS) in said first operation condition, and not controlled by an operating system (OS) in said second operation condition.

14. The portable computer according to claim 12 wherein said computer host is shutdown in said second operation condition.

15. The portable computer according to claim 12 wherein said foreign image signal is a digital modulating image signal of a transmission minimized differential signaling (TMDS) format.

16. The portable computer according to claim 15 wherein said display device includes a receiver for receiving said foreign digital modulating image signal in said first operation condition, and said local image signal in said second operation condition.

17. The portable computer according to claim 16 wherein said receiver is a low voltage differential signaling (LVDS) receiver and said signal transferring device includes:
a digital visual interface (DVI) connector in communication with said signal output channel of said external image-signal generator for receiving said foreign digital modulating image signal;
a first TMDS receiver in communication with said DVI connector for recovering said foreign digital modulating image signal into a digital image data; and
a second LVDS transmitter in communication with said TMDS receiver for outputting a digital modulating image data of a first LVDS format converted from said digital image data.

18. The portable computer according to claim 16 wherein said receiver is a TMDS receiver, and said signal transferring device includes:
a digital visual interface (DVI) connector in communication with said signal output channel of said external image-signal generator for receiving said foreign digital modulating image signal; and
a first TMDS transmitter in communication with said DVI connector for directly outputting said foreign digital modulating image signal.
